(19) United States
(12) Patent Application Publication
(10) Pub. No.: US 2017/0299912 A1
(43) Pub. Date: Oct. 19, 2017

(54) INTELLIGENT DISPLAY DEVICE

(71) Applicant: BOE TECHNOLOGY GROUP CO., LTD, Beijing (CN)

(72) Inventors: LONG WANG, Beijing (CN); Li ZHOU, Beijing (CN); Yanzhao LI, Beijing (CN)

(21) Appl. No.: 15/517,819

(22) PCT Filed: Mar. 4, 2016
(86) PCT No.: PCT/CN2016/075648

§ 371 Date: Apr. 7, 2017

(30) Foreign Application Priority Data
Mar. 30, 2015 (CN) 201510145121.X

(51) Int. Cl. G02F 1/1333; G09G 3/3208

(52) U.S. Cl. CPC G02F 1/133305; G09G 3/3208; B32B 2457/20

(57) ABSTRACT

An intelligent display device. The intelligent display device comprises a control film layer and a display film layer that is used for displaying pattern information. The display film layer is disposed on the control film layer. The control film layer is used for controlling the display information of the display film layer according to an instruction sent by a corresponding mobile terminal. The harm to a human body, caused by nail polish that is used by users and contains a harmful matter, can be avoided, time is saved, the operation complexity is lowered, and different requirements of users can be met when the users stay at home.

### TECHNICAL FIELD

The embodiment of the present disclosure relates to an intelligent display device.

### BACKGROUND

In recent years, the wearable display technology has received much concern, and smart wristbands, smart watches, smart glasses and the like appear frequently. Google, Samsung, Baidu, Nike and many other well-known manufacturers have launched their own representative products, for instance, Google glass, Galaxy Gear watch, Boom Band wristband and Fuelband smart fitness wristband. These products mainly focus on the enhancement of the practical entertainment experience, health monitoring, sports monitoring, etc. Currently, many domestic manufacturers also get into the market. As the products have similar functions and shapes, the homogenization phenomenon is very obvious, so more innovative products must be developed.

Meanwhile, with the continuous development of people's living standards, many ladies dress themselves by nail manicure, headdress, backpack, etc. However, the traditional nail polish contains chemical compositions such as nitrocellulose, acetone, ethyl acetate, ethyl lactate and phthalic acid tincture. Although finger nails can look more colorful, the toxic and harmful chemical compositions in the nail polish will have a chronic injury on the body, and will also have an impact on the health of children in particular to women in pregnancy or lactation. In addition, the nail polishes with more decorations and various patterns must be provided in special storefronts, so that not only time is wasted but also the operation is very complex.

### SUMMARY

The embodiment of the present disclosure provides an intelligent display device, which solves the problem that the nail polish used in the conventional nail manicure technology contains substances harmful to the human body.

According to at least one embodiment of this disclosure, an intelligent display device is provided, comprising: a control layer and a display layer for displaying pattern information, wherein the display layer is disposed on the control layer; and the control layer is configured to control display information of the display layer according to an instruction sent by corresponding mobile terminal.

Optionally, the device further comprising: a bonding layer, wherein the bonding layer is disposed at position, corresponding to the control layer, beneath the control layer; and the bonding layer is configured to fix the intelligent display device on a preset object.

Optionally, the control layer includes: a power module, a first display control module and a first data transmission module, in which

the power module is respectively connected with the first data transmission module and the first display control module; the first data transmission module is connected with the first display control module; the power module is configured to provide a power supply signal for the intelligent display device; the first data transmission module is configured to send the display information to the first display control module according to the received instruction sent by the mobile terminal; and the first display control module is configured to receive the display information sent by the first data transmission module, and display the display information on the display layer.

Optionally, the control layer includes: a second display control module and a second data transmission module, in which the second display control module is connected with the second data transmission module; the second data transmission module is configured to send the display information to the second display control module according to the received instruction sent by the mobile terminal; and the second display control module is configured to receive the display information sent by the second data transmission module, and display the display information on the display layer.

Optionally, the device further comprising: a transparent power supply layer disposed on the display layer.

Optionally, the device further comprising: a first protective layer and a first decorative layer, wherein the first protective layer is disposed on the display layer; and the first decorative layer is disposed on the first protective layer or between the display layer and the first protective layer.

Optionally, the device further comprising: a second protective layer and a second decorative layer, wherein the second protective layer is disposed on the transparent power supply layer; and the second decorative layer is disposed on the second protective layer or between the transparent power supply layer and the second protective layer.

Optionally, the thickness of the display layer is set to be less than or equal to 0.5 mm.

Optionally, the thickness of the control layer is set to be 10-100 μm.

Optionally, the thickness of the first protective layer and the second protective layer is set to be less than or equal to 0.1 mm.

Optionally, the first data transmission module is also configured to determine whether to charge the power module through the mobile terminal.

### BRIEF DESCRIPTION OF THE DRAWINGS

In order to make the embodiments of the disclosure apparent, the drawings related to the embodiments of the disclosure will be described briefly. Apparently, the described embodiments are just a part of the embodiments of the disclosure. For those skilled in the art, he or she can obtain other figure(s) according to these figures, without any inventive work.

FIG. 1 is a schematic structural view of an intelligent display device provided by the embodiment of the present disclosure;

FIG. 2 is a schematic structural view of another intelligent display device provided by the embodiment of the present disclosure;

FIG. 3 is a schematic structural view of still another intelligent display device provided by the embodiment of the present disclosure;

FIG. 4 is a schematic structural view of an intelligent display device provided by another embodiment of the present disclosure;

FIG. 5 is a schematic structural view of another intelligent display device provided by another embodiment of the present disclosure;

FIG. 6 is a schematic structural view of still another intelligent display device provided by another embodiment of the present disclosure;

FIG. 7 is a schematic structural view of an intelligent display device provided by still another embodiment of the present disclosure;

FIG. 8 is a schematic structural view of another intelligent display device provided by still another embodiment of the present disclosure; and

FIG. 9 is a schematic structural view of still another intelligent display device provided by still another embodiment of the present disclosure.

### REFERENCE NUMERALS OF THE ACCOMPANYING DRAWINGS

1—control layer;
2—display layer;
3—bonding layer;
11—power module;
12—first display control module;
13—first data transmission module;
14—second display control module;
15—second data transmission module;
4—transparent power supply layer;
5—first protective layer;
6—first decorative layer;
7—second protective layer;
8—second decorative layer.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

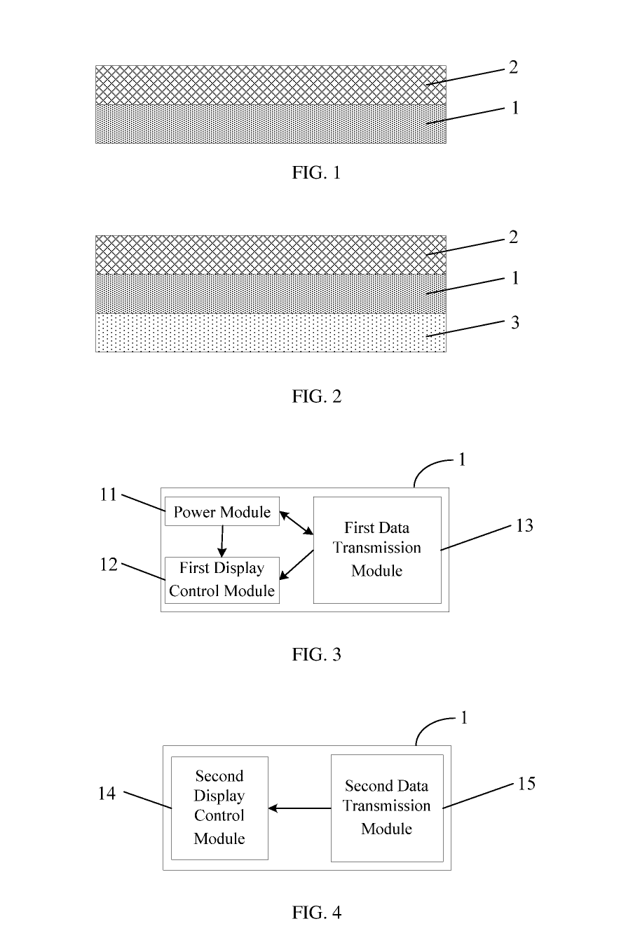

The embodiment of the present disclosure provides an intelligent display device. As illustrated in FIG. 1, the intelligent display device comprises: a control layer 1 and a display layer 2 for displaying pattern information. The display layer 2 may be disposed on the control layer 1.

The display layer 2 may adopt the design of low power consumption and low resolution, for instance, may include an active or passive driving circuit. In actual application, in the embodiment of the present disclosure, in order to bond the intelligent display device to the fingernail, a flexible display may be adopted as the display layer. For instance, e-paper display, reflective liquid-crystal display (LCD), micro-electromechanical system (MEMS) display, organic light-emitting diode (OLED) display or the like may be adopted. Meanwhile, in order to save more power in the process of displaying a static image, memory elements may be designed in pixels of a display device adopting a low-temperature polysilicon thin-film transistor (LTPS-TFT) array substrate, or low-frequency driving technology is adopted on the basis of an oxide thin-film transistor (TFT) substrate. Optionally, the thickness of the display layer 2 is less than or equal to 0.5 mm.

The control layer 1 is configured to control display information of the display layer 2 according to an instruction sent by corresponding mobile terminal.

Optionally, the control layer 1 has the function of being connected with the mobile terminal. Once the connection relationship between the intelligent display device and the mobile terminal is created under the control of the control layer, a user may set patterns or colors required for display on the mobile terminal in advance according to own requirements, and the colors or patterns set in advance by the user can be displayed on the display layer under the control of the control layer. Optionally, the thickness of the control layer 1 is 10-100 μm.

In the intelligent display device provided by the embodiment of the present disclosure, by adoption of the novel intelligent display device comprising the control layer 1 and the display layer for displaying pattern information, the display layer 2 is disposed on the control layer 1; the control layer 1 is configured to control display information of the display layer according to an instruction sent by corresponding mobile phone; and the intelligent display device is disposed on the fingernail. As long as the connection relationship with the mobile terminal is created, the user can randomly choose their own favorite colors and patterns according to own requirements at all times and places. The embodiment provides a method for solving the problem that the nail polish used in the conventional nail manicure technology contains the substances harmful to the human body, avoids the use of the nail polish containing harmful substances, and then avoids the harm to the human body. Meanwhile, the embodiment is time-saving, reduces the operation complexity, and improves the experience effect of the user.

Moreover, optionally, as shown in FIG. 2, the intelligent display device may further comprise a bonding layer 3.

The bonding layer 3 is disposed at a position, corresponding to the control layer 1, beneath the control layer 1. The bonding layer 3 may be configured to fix the intelligent display device on a preset object. The bonding layer 3 may adopt an adhesive with good biocompatibility and in accordance with the medical standards, for instance, may adopt non-setting adhesive or double-faced adhesive tape in accordance with the medical standards. The preset object in the embodiment may be fingernail, skin or hair and may also be jewelry, clothing, furniture, electrical appliance or wall. It should be understood by those skilled in the art that the above example is not intended to limit the present disclosure. The preset object may be any object on which the intelligent display device can be fixed. Description is given in the embodiment to the proposal of the embodiment by only taking the fingernail as an example.

Optionally, the thickness of the bonding layer is the thinner the better, as long as it is ensured that the intelligent display device can be bonded to the fingernail.

Optionally, as shown in FIG. 3, the control layer 1 may include: a power module 11, a first display control module 12 and a first data transmission module 13.

One end of the power module 11 is connected with one end of the first data transmission module 13, and the other end of the power module 11 is connected with one end of the first display control module 12.

The other end of the first data transmission module 13 is connected with the other end of the first display control module 12.

The power module 11 is configured to provide a power supply signal for the intelligent display device.

The first data transmission module 13 is configured to send the display information to the first display control module 12 according to the received instruction sent by the mobile terminal.

In addition, optionally, the first data transmission module 13 is also configured to determine whether to charge the power module 11 through the mobile terminal. When charging is determined to be required, the first data transmission module 13 may automatically create the charging connection between the power module 11 and the mobile terminal, so as to charge the power module 11.

The first data transmission module 13, for instance, may be a microprocessor chip and/or a program instruction having the functions of data storage, processing and transmission.

The first display control module 12 is configured to receive the display information sent by the first data transmission module 13 and display the display information on the display layer 2. The first display control module 12, for instance, may be an image processor, an imaging system and/or a program instruction having the functions of data storage, processing and transmission.

In addition, the power module 11 may adopt thin-film cells, for instance, all solid state thin-film lithium ion batteries. The thickness of the thin-film cells may be 10-100 μm.

As shown in FIG. 4, according to another example of the embodiment of the present disclosure, the control layer 1 may also include a second display control module 14 and a second data transmission module 15. The second display control module 14 is connected with the second data transmission module 15.

The second data transmission module 15 is configured to send the display information to the second display control module 14 according to the received instruction sent by the mobile terminal.

The second display control module 14 is configured to receive the display information sent by the second data transmission module 15 and display the display information on the display layer 2.

The first data transmission module and the second data transmission module may be implemented by same functional module, e.g., software, hardware or firmware. The first data transmission module and the second data transmission module may achieve the connection between the intelligent display device and the mobile terminal by a wireless signal such as WIFI, an infrared signal, a radio frequency identification (RFID) signal and a near field communication (NFC) signal, and finally achieve the control of the display information of the intelligent display device via the mobile terminal.

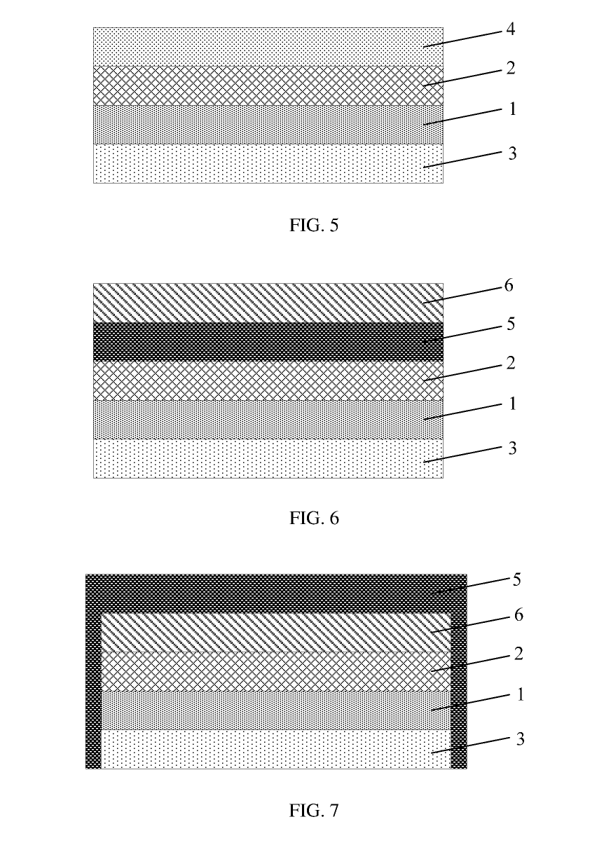

Moreover, as shown in FIG. 5, when the control layer 1 includes the second display control module 14 and the second data transmission module 15, on this basis, the intelligent display device further comprises: a transparent power supply layer 4 disposed on the display layer 2. When the control layer 1 includes the power module 11, the first display control module 12 and the first data transmission module 13, the intelligent display device may also comprise a transparent power supply layer 4 disposed on the display layer 2.

As shown in FIG. 6, the intelligent display device further comprises a first protective layer 5 and a first decorative layer 6. Optionally, the first protective layer 5 is disposed on the display layer 2.

On the basis of the control layer as shown in FIG. 3, as shown in FIG. 6, the first decorative layer 6 may be disposed on the first protective layer 5; or on the basis of the control layer as shown in FIG. 4, as shown in FIG. 7, the first decorative layer 6 may also be disposed between the display layer 2 and the first protective layer 5.

Optionally, the first protective layer as shown in FIG. 6 may be a general protective layer, as long as the function of protecting the display layer 2 and preventing the display layer 2 from being damaged can be achieved. The first protective layer as shown in FIG. 7 may simultaneously have waterproof function when achieving the function of protecting the display layer 2 and preventing the display layer 2 from being damaged. Therefore, the first protective layer must cover the entire intelligent display device.

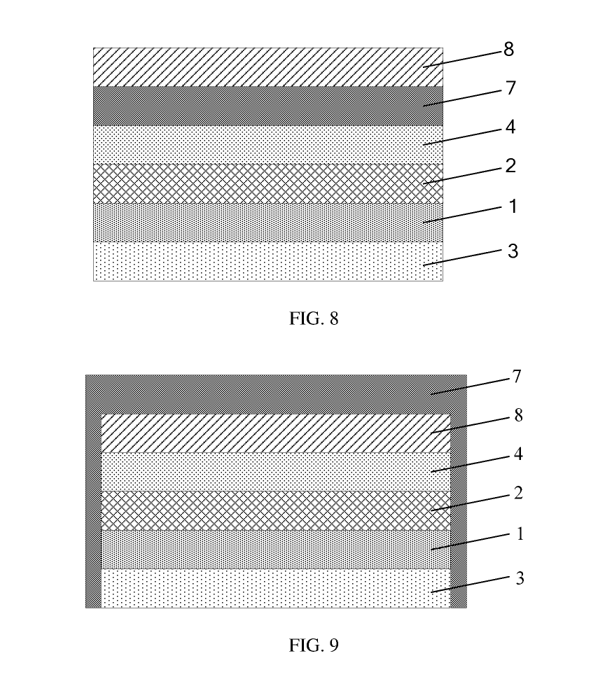

Moreover, optionally, as shown in FIG. 8, the intelligent display device further comprises a second protective layer 7 and a second decorative layer 8. Optionally, the second protective layer 7 is disposed on the transparent power supply layer 4.

On the basis of the control layer as shown in FIG. 3, as shown in FIG. 8, the second decorative layer 8 may be disposed on the second protective layer 7. Or on the basis of the control layer as shown in FIG. 4, as shown in FIG. 9, the second decorative layer 8 may also be disposed between the transparent power supply layer 4 and the second protective layer 7.

Optionally, the first protective layer as shown in FIG. 8 may be a general protective layer, as long as the function of protecting the display layer and preventing the display layer from being damaged can be achieved. The first protective layer as shown in FIG. 9 may simultaneously have waterproof function when achieving the function of protecting the display layer and preventing the display layer from being damaged. Therefore, the first protective layer must cover the entire intelligent display device.

The thickness of the first protective layer 5 and the second protective layer 7 is less than or equal to 0.1 mm.

It should be noted that the thickness of the first decorative layer and the second decorative layer is not specifically limited in the embodiment, and may be determined in actual design according to actual decorative requirements.

Description will be given below to the working process of the intelligent display device corresponding to the control layer as shown in FIG. 3. The intelligent display device includes nail manicure display mode, nail manicure switching mode, charging mode and information prompt mode. In the nail manicure display mode, the display layer only needs to display a static image, so the power consumption is low. At this point, the first data transmission module and the first display control module are in low-power sleep state, and may be awakened at any time according to actual needs. In the nail manicure switching mode, the mobile terminal sends a signal of display information required for switching to the first data transmission module. After identifying the display information, the first data transmission module sends the display information to the first display control module. The first display control module displays the display information on the display layer. Meanwhile, the first data transmission module may also send the display information to the power module, so that the power module can adjust the brightness of the display layer according to the change of the display information. Thus, optimum power consumption can be achieved, so that the consumption can be reduced. Of course, in actual operation, the information that a single fingernail is pasted by a pattern may be switched, or the information that a plurality of and even all the fingernails are pasted by patterns may also be switched. The actual switching process and whether the switching task is completed may be specifically determined by setting the interval of pattern switching of intelligent display devices disposed on different fingernails, or the switching of actual nail manicure patterns may also be achieved by the user's autonomous setting on the mobile terminal. In the information prompt mode, the first data transmission module may automatically identify whether there is short message, call or other information in the mobile terminal, and may send instruction information to the first display control module when determining that the mobile terminal receives information. Meanwhile, the first data transmission module controls the information display of the display layer through the power module and the first display control module, so as to prompt the user that the mobile terminal has received information. For instance, flicker may be adopted to notify the user that the mobile terminal has received information. In the charging mode, the first data transmission module may automatically create the charging connection between the power module and the mobile terminal, so as to charge the power module.

Optionally, description will be given below to the working principle of the intelligent display device corresponding to the control layer as shown in FIG. 4: the intelligent display device still includes nail manicure display mode, nail manicure switching mode, charging mode and information prompt mode. But the charging mode of the intelligent display device at this point is different from the charging mode of the intelligent display device as shown in FIG. 3. The control layer of the intelligent display device is not provided with the power module but provided with the transparent power supply layer 4. The transparent power supply layer may specifically be transparent thin-film solar cells. In the case of insufficient power, the transparent power supply layer may be automatically charged by sunlight and does not need to be charged by the mobile terminal. Other working modes are the same with the working modes of the intelligent display device corresponding to the control layer as shown in FIG. 3. No further description will be given here.

Of course, optionally, it should be understood by those skilled in the art that the intelligent display device may have a plurality of charging modes. For instance, not only the transparent power supply layer is included but also the power module is included. When the transparent power supply layer may be adopted for charging, for instance, in the sun, the transparent power supply layer may be adopted for charging. In the absence of sun, the power in the power module is used, and the power module is charged as required.

In the intelligent display device provided by the embodiment of the present disclosure, by adoption of the novel intelligent display device comprising the control layer and the display layer for displaying pattern information, the display layer is disposed on the control layer; the control layer is configured to control the display information of the display layer according to the instruction sent by corresponding mobile terminal; the intelligent display device is disposed on the fingernail; and as long as the connection relationship with the mobile terminal is created, the user can randomly choose their own favorite colors and patterns according to own requirements at all times and places. The embodiment provides a method for solving the problem that the nail polish used in the conventional nail manicure technology contains the substances harmful to the human body. The method avoids the use of the nail polish containing harmful substances, and then avoids the harm to the human body. Meanwhile, the embodiment is time-saving, reduces the operation complexity, can satisfy different requirements of users staying indoors, and improves the experience effect of the user.

The foregoing is only the preferred embodiments of the present disclosure and not intended to limit the scope of protection of the present disclosure. The scope of protection of the present disclosure should be defined by the appended claims.

The application claims priority to the Chinese patent application No. 201510145121.X, filed Mar. 30, 2015, the disclosure of which is incorporated herein by reference as part of the application.

1. An intelligent display device, comprising: a control layer and a display layer for displaying pattern information, wherein
the display layer is disposed on the control layer; and
the control layer is configured to control display information of the display layer according to an instruction sent by corresponding mobile terminal.

2. The device according to claim 1, further comprising: a bonding layer, wherein
the bonding layer is disposed at position, corresponding to the control layer, beneath the control layer; and
the bonding layer is configured to fix the intelligent display device on a preset object.

3. The device according to claim 1, wherein the control layer includes: a power module, a first display control module and a first data transmission module, in which
the power module is respectively connected with the first data transmission module and the first display control module;
the first data transmission module is connected with the first display control module;
the power module is configured to provide a power supply signal for the intelligent display device;
the first data transmission module is configured to send the display information to the first display control module according to the received instruction sent by the mobile terminal; and
the first display control module is configured to receive the display information sent by the first data transmission module, and display the display information on the display layer.

4. The device according to claim 1, wherein the control layer includes: a second display control module and a second data transmission module, in which
the second display control module is connected with the second data transmission module;
the second data transmission module is configured to send the display information to the second display control module according to the received instruction sent by the mobile terminal; and
the second display control module is configured to receive the display information sent by the second data transmission module, and display the display information on the display layer.

5. The device according to claim 1, further comprising: a transparent power supply layer disposed on the display layer.

6. The device according to claim 1, further comprising: a first protective layer and a first decorative layer, wherein
the first protective layer is disposed on the display layer; and
the first decorative layer is disposed on the first protective layer or between the display layer and the first protective layer.

7. The device according to claim 5, further comprising: a second protective layer and a second decorative layer, wherein
the second protective layer is disposed on the transparent power supply layer; and
the second decorative layer is disposed on the second protective layer or between the transparent power supply layer and the second protective layer.

8. The device according to claim 1, wherein
the thickness of the display layer is set to be less than or equal to 0.5 mm.

9. The device according to claim 1, wherein
the thickness of the control layer is set to be 10-100 μm.

10. The device according to claim 6, wherein
the thickness of the first protective layer and the second protective layer is set to be less than or equal to 0.1 mm.

11. The device according to claim 3, wherein the first data transmission module is also configured to determine whether to charge the power module through the mobile terminal.

12. The device according to claim 2, wherein the control layer includes: a power module, a first display control module and a first data transmission module, in which
the power module is respectively connected with the first data transmission module and the first display control module;
the first data transmission module is connected with the first display control module;
the power module is configured to provide a power supply signal for the intelligent display device;
the first data transmission module is configured to send the display information to the first display control module according to the received instruction sent by the mobile terminal; and
the first display control module is configured to receive the display information sent by the first data transmission module, and display the display information on the display layer.

13. The device according to claim 2, wherein the control layer includes: a second display control module and a second data transmission module, in which
the second display control module is connected with the second data transmission module;
the second data transmission module is configured to send the display information to the second display control module according to the received instruction sent by the mobile terminal; and
the second display control module is configured to receive the display information sent by the second data transmission module; and
display the display information on the display layer.

14. The device according to claim 2, further comprising: a transparent power supply layer disposed on the display layer.

15. The device according to claim 3, further comprising: a transparent power supply layer disposed on the display layer.

16. The device according to claim 4, further comprising: a transparent power supply layer disposed on the display layer.

17. The device according to claim 2, further comprising: a first protective layer and a first decorative layer, wherein
the first protective layer is disposed on the display layer; and
the first decorative layer is disposed on the first protective layer or between the display layer and the first protective layer.

18. The device according to claim 3, further comprising: a first protective layer and a first decorative layer, wherein
the first protective layer is disposed on the display layer; and
the first decorative layer is disposed on the first protective layer or between the display layer and the first protective layer.

19. The device according to claim 4, further comprising: a first protective layer and a first decorative layer, wherein
the first protective layer is disposed on the display layer; and
the first decorative layer is disposed on the first protective layer or between the display layer and the first protective layer.

20. The device according to claim 5, further comprising: a first protective layer and a first decorative layer, wherein
the first protective layer is disposed on the display layer; and
the first decorative layer is disposed on the first protective layer or between the display layer and the first protective layer.
